(19) United States
(12) Patent Application Publication
(10) Pub. No.: US 2022/0011520 A1
(43) Pub. Date: Jan. 13, 2022

(54) SHUTTER SHAFT HOLDING STRUCTURE IN ADAPTER WITH SHUTTER

(71) Applicant: SANWA DENKI KOGYO CO., LTD., Tokyo (JP)

(72) Inventor: Takashi SATO, Tokyo (JP)

(21) Appl. No.: 17/319,124

(22) Filed: May 13, 2021

(30) Foreign Application Priority Data
Jul. 10, 2020 (JP) 2020-118989

(51) Int. Cl. G02B 6/38

(52) U.S. Cl. CPC G02B 6/387; G02B 6/381

(57) ABSTRACT

The invention provides a shutter shaft holding structure in an adapter with shutter in which the closure of the butt ends of two upper and lower shutter members is always held firmly in the exact position. U-shaped arms (3a, 3b) are protruded in an adapter including shutter members (6a, 6b) in an insertion slot for connecting both male and female plugs (P1, P2) to face to each other, mating concave portions (4a, 4b) are provided in upper and lower positions of each of the arms (3a, 3b) in a leading end side, shutter shafts (5a, 5b) of the shutter members (6a, 6b) are rotatably pivoted to the mating concave portions (4a, 4b), and the shutter shafts are pressed and retained by a cover (8) put on the arms (3a, 3b).

### TECHNICAL FIELD

The present invention relates to a shutter shaft holding structure in an adapter with shutter.

### BACKGROUND ART

Conventionally, as disclosed in patent literature 1, there has been known an optical fiber adapter including a first adapter main body, a shielding door elastically connected by hinge to a lower end port of the first adapter main body, and a second adapter main body having a lower end portion inserted into a casing of the first adapter main body, in which a stretching post and an engagement arm extend downward in an end surface of the lower end portion of the second adapter main body, the stretching post is pressed to both ends of a hinge connecting shaft of the shielding door, and the engagement arm is exposed outside of the shielding door, and is engaged with an optical fiber connector connection portion inserted into a lower end of the first adapter main body.

Further, as disclosed in patent literature 2, there has been known an optical fiber adapter in which a pivot shaft is formed in a front side of a first shutter member, an extension portion extends from a rear side of the first shutter member at an angle between 90 and 180 degrees, the extension portion has an inclined surface formed in a rear side thereof, a slot extending laterally is formed in the first shutter member, a pivot shaft is formed in a front side of a second shutter member, and an extension portion extends from a rear side of the second shutter member at an angle between 90 and 180 degrees. In this structure, the optical fiber adapter is configured to press the first shutter member and a first drive portion and move them toward a third wall by insertion of the first optical fiber connector from a second opening portion, and press the second shutter member and a second drive portion and move toward a first wall.

### CITATION LIST

### Patent Literature

Patent Literature 1: Chinese Utility Model No. CN208833957

Patent Literature 2: Japanese Patent No. 6458093

### SUMMARY OF INVENTION

### Technical Problem

However, the conventional patent literature 1 is configured to be pressed to four stretching posts arranged in both ends of an engagement arm from the above in both ends of a hinge connecting shaft of a shielding door. In the meantime, in the patent literature 2, a shutter shaft is configured to be simply fixed within a housing. In these prior arts, the shutter shaft is loosely fixed and a shaft misalignment tends to occur. Therefore, it is less likely that the closure of the butt ends of two upper and lower shutter members is always held firmly in the exact position.

More specifically, in the patent literature 1, the stretching post and the engagement arm extend downward in the end surface of the lower end portion of the second adapter main body, the stretching post is pressed to both ends of the hinge connecting shaft of the shielding door, and the engagement arm is exposed outside the shielding door, and is engaged with the optical fiber connector connection portion inserted into the lower end of the first adapter main body. Therefore, it is less likely that the closure of the butt ends of two upper and lower shielding doors (shutter members) is always held firmly in the exact position.

Further, the patent literature 2 is configured to press the first shutter member and the first drive portion and move them toward the third wall and to press the second shutter member and the second drive portion and move them toward the first wall on the basis of the insertion of the first optical fiber connector from the second opening portion. As a result, the shutter shaft is loosely fixed and the shaft misalignment tends to occur. Therefore, it is less likely that the closure of the butt ends of two upper and lower shielding doors (shutter members) is always held firmly in the exact position.

Accordingly, the present invention is made by taking into consideration the conventionally existing various circumstances as mentioned above, and an object of the present invention is to provide a shutter shaft holding structure in an adapter with shutter in which the closure of the butt ends of two upper and lower shutter members is always held firmly in the exact position.

### Solution to Problem

In order to achieve the object mentioned above, according to the present invention, there is provided an adapter including a shutter member in an insertion slot for connecting both male and female plugs, wherein U-shaped arms are protruded in the adapter to face to each other, mating concave portions are provided in upper and lower positions of each of the arms, shutter shafts formed in respective one ends of the shutter member are fitted into the mating concave portions, and the shutter shafts are pressed by a cover put on the arms, thereby forming the shutter member so as to be axially supported within the adapter rotatably.

The adapter is formed by a first adapter into which any one of the male and female plugs is inserted and in which the U-shaped arms are provided, and a second adapter which is formed by attaching the cover to an outer periphery of the arms of the first adapter.

A pair of shutter members each including the shutter shaft in an end portion thereof are arranged in upper and lower sides within the adapter, and at least one of the shutter members is provided with a recess with which a ferrule of the inserted adapter is not brought into contact.

The mating concave portion is arranged in a leading end side of each of the arms, and is formed into a semicircular shape so that a cylindrical shutter shaft is fitted.

A spring member is provided so that the pair of upper and lower shutter members are biased at a closed position by pressing the shutter shaft fitted to the mating concave portion by the cover put on the arms.

The spring member is provided at the center with a bent portion so as to be inserted and locked to an opening portion formed along an inner side of the shutter shaft of the shutter member, and is formed via the bent portion into a bifurcated shape which is approximately perpendicular in a side view.

### Effect of Invention

According to the present invention, the closure of the butt ends of two upper and lower shutters can be always held firmly in the exact position.

More specifically, in the present invention, in the adapter including the shutter member in the insertion slot for connecting both the male and female plugs, the U-shaped arms are protruded in the adapter to face to each other, the mating concave portions are provided in the upper and lower positions of each of the arms, the shutter shafts formed in respective one ends of the shutter member are fitted into the mating concave portions, and the shutter shafts are pressed by the cover put on the arms, thereby forming the shutter member so as to be axially supported within the adapter rotatably. As a result, the present adapter can be always held firmly in the exact position when the shutter member is closed before the plug is inserted.

The adapter is formed by the first adapter into which any one of the male and female plugs is inserted and in which the U-shaped arms are provided, and the second adapter which is formed by attaching the cover to the outer periphery of the arms of the first adapter. As a result, the second adapter can be easily coupled to and formed in the first adapter by the attachment of the cover.

The pair of shutter members each including the shutter shaft in the end portion thereof are arranged in the upper and lower sides within the adapter, and at least one of the shutter members is provided with the recess with which the ferrule of the inserted adapter is not brought into contact. As a result, it is possible to insert without damaging the ferrule of the plug.

The mating concave portion is arranged in the leading end side of each of the arms, and is formed into the semicircular shape so that the cylindrical shutter shaft is fitted. As a result, it is possible to simultaneously and smoothly rotate the pair of upper and lower shutter members.

The spring member is provided so that the pair of upper and lower shutter members are biased at the closed position by pressing the shutter shaft fitted to the mating concave portion by the cover put on the arms. As a result, it is possible to always bias the butt ends of the pair of upper and lower shutter members securely in the same closed position.

The spring member is provided at the center with the bent portion so as to be inserted and locked to the opening portion formed along the inner side of the shutter shaft of the shutter member, and is formed via the bent portion into the bifurcated shape which is approximately perpendicular in the side view. As a result, one end of the spring member is pressed by the cover, whereby the pair of upper and lower shutter members can be always biased securely in the same closed position by the other end of the spring member via the center bent portion.

### BRIEF DESCRIPTION OF DRAWINGS

FIG. 1 is an exploded perspective view of an adapter and shows an embodiment for executing the present invention.

FIG. 2 is a perspective view of the adapter after being assembled.

FIGS. 3A to 3E show an example of the adapter, in which FIG. 3A is a plan view, FIG. 3B is a front elevational view, FIG. 3C is a back elevational view, FIG. 3D is a side elevational view and FIG. 3E is a bottom elevational view.

FIG. 4 is a cross sectional view of the adapter in a state in which a shutter member is closed.

FIG. 5 is a cross sectional view of the adapter in a state in which the shutter member is opened.

FIGS. 6A to 6G show an example of a lower shutter member, in which FIG. 6A is a plan view, FIG. 6B is a front elevational view, FIG. 6C is a back elevational view, FIG. 6D is a side elevational view, FIG. 6E is a bottom elevational view, FIG. 6F is a cross sectional view and FIG. 6G is a perspective view.

FIGS. 7A to 7G show an example of an upper shutter member, in which FIG. 7A is a plan view, FIG. 7B is a front elevational view, FIG. 7C is a back elevational view, FIG. 7D is a side elevational view, FIG. 7E is a bottom elevational view, FIG. 7F is a cross sectional view and FIG. 7G is a perspective view.

FIGS. 8A to 8C show an example of a spring member, in which FIG. 8A is a plan view, FIG. 8B is a front elevational view and FIG. 8C is a side elevational view.

FIG. 9 is a cross sectional view showing a first connecting step of the adapter.

FIG. 10 is a cross sectional view showing a second connecting step of the adapter.

FIG. 11 is a cross sectional view showing a third connecting step of the adapter.

FIG. 12 is a cross sectional view showing a fourth connecting step of the adapter.

### DESCRIPTION OF EMBODIMENTS

A description will be in detail given below of an embodiment of a shutter shaft holding structure in an adapter with shutter according to the present invention with reference to the accompanying drawings.

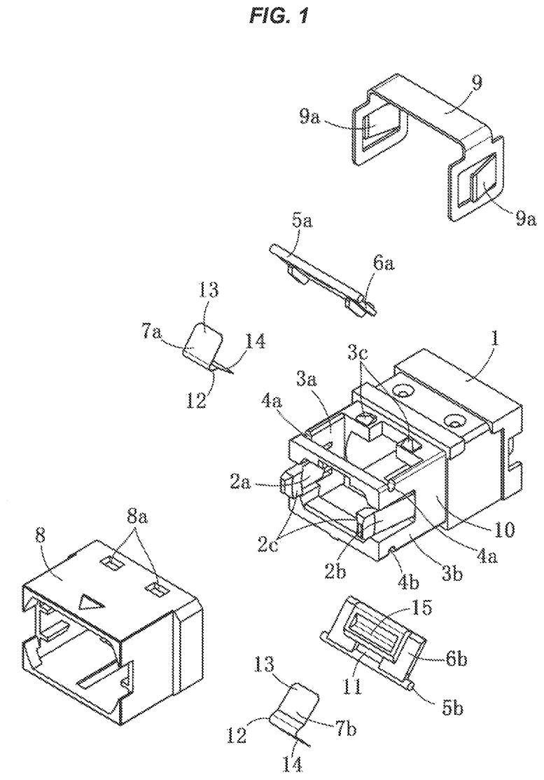

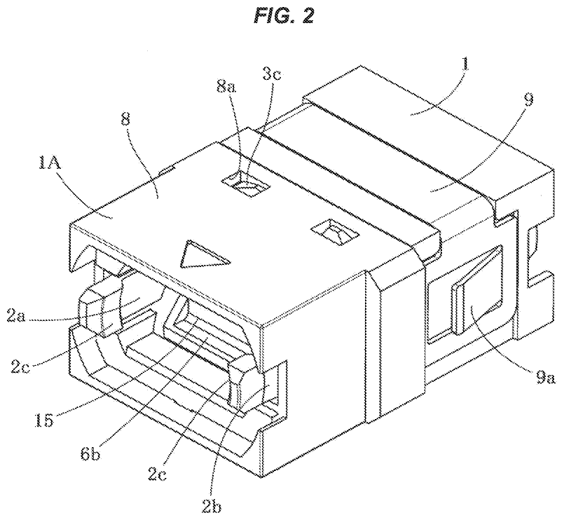

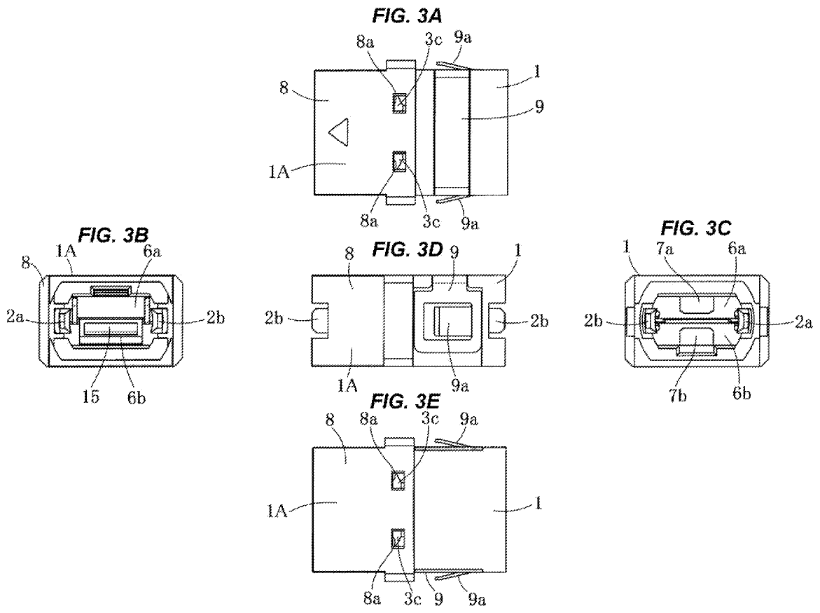

The present embodiment is configured to include a first adapter 1 formed into a rectangular casing shape, and a second adapter 1A integrally connected to a casing end portion of the first adapter 1, provided in an opposing manner with U-shaped arms 3a and 3b having locking members 2a and 2b at the center thereof so as to form a pair in left and right sides of an insertion slot, and including a pair of upper and lower shutter members 6a and 6b which are provided in end portions thereof with shutter shafts 5a and 5b rotatably pivoted to mating concave portions 4a and 4b respectively provided in upper and lower positions of the arms 3a and 3b in their leading end sides, spring members 7a and 7b which bias the shutter members 6a and 6b to a closed position, and a cover 8 which is put on outer peripheries of the arms 3a and 3b in the adapter 1, locks and retains the spring members 7a and 7b by bringing the spring members into contact with an inner wall thereof, and is formed into a rectangular tube casing shape, as shown in FIGS. 1, 2 and FIGS. 3A to 3E.

Further, the present embodiment is provided with a fastener 9 which is mounted to the adapter 1 from the above, has elastic locking pieces 9a in both ends thereof and is formed into an approximately U-shaped frame shape. The locking members 2a and 2b are provided in the first adapter 1 side so as to form a pair in left and right of the insertion slot.

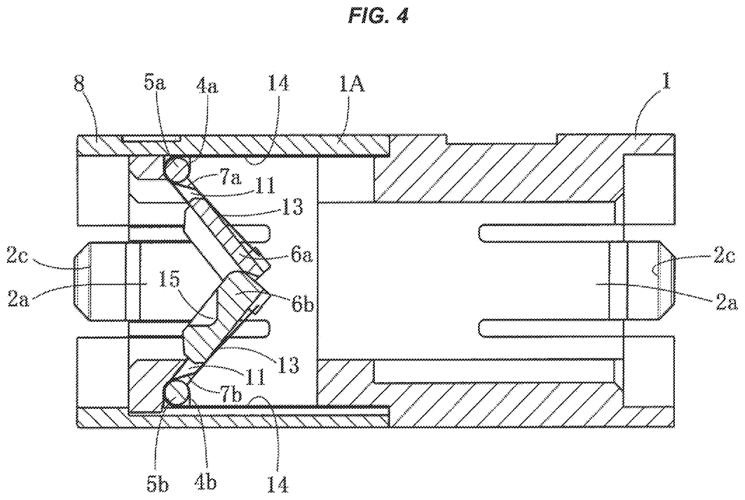

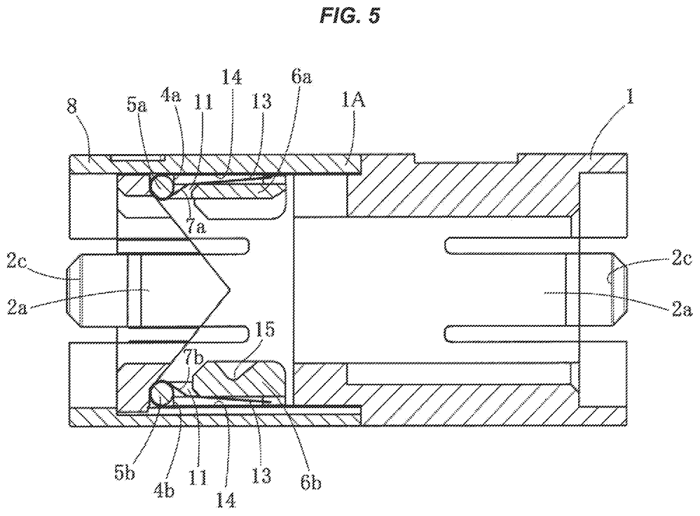

As shown in FIGS. 4 and 5, the arms 3a and 3b of the second adapter 1A are provided at upper and lower positions to protrude from a base portion 10 connected to the adapter 1 and formed into a rectangular tube shape, and mating concave portions 4a and 4b respectively provided at upper and lower positions of the arms 3a and 3b in leading end sides thereof are formed into a semicircular shape so as to rotatably pivot the cylindrical shutter shafts 5a and 5b.

Further, the arm-shaped locking members 2a and 2b provided at the middle portion of the arms 3a and 3b extend to outer sides of the shutter members 6a and 6b, and have claw portions 2c directed inward each other in leading ends thereof for locking a female side plug P2 inserted into opening ends at the center of the second adapter arms 3a and 3b.

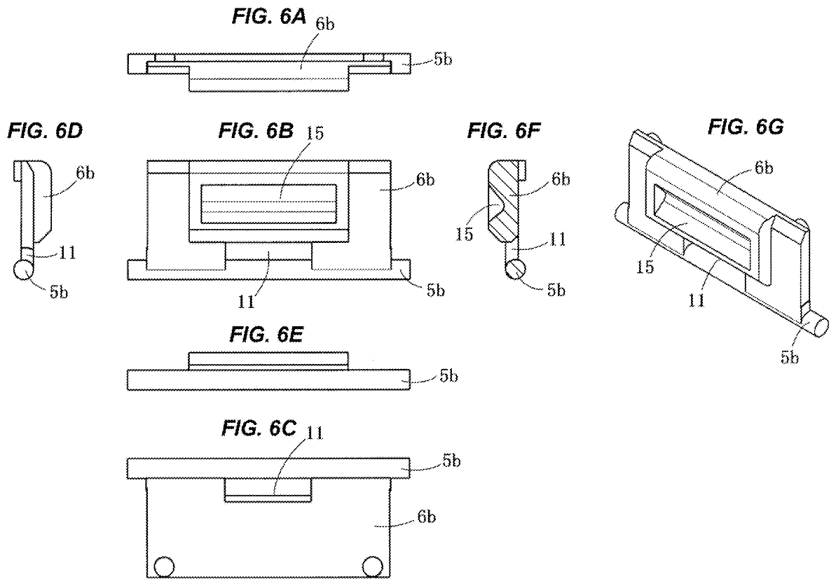

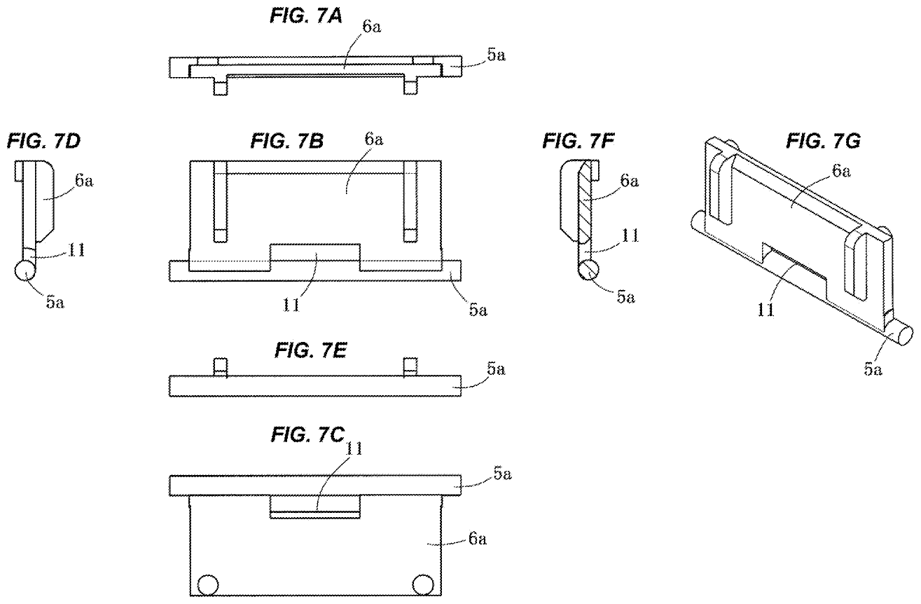

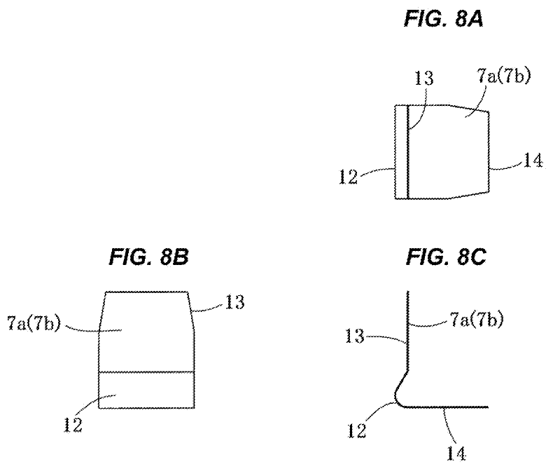

As shown in FIGS. 6A to 6G and FIGS. 7A to 7G, the shutter members 6a and 6b are provided with the cylindrical shutter shafts 5a and 5b in one end sides thereof, and are provided at the center thereof with opening portions 11 and 11 which allow the spring members 7a and 7b bent at an angle of about 90 degrees shown in FIGS. 8A to 8C to insert and lock along the shutter shafts 5a and 5b.

More specifically, a center bend portion 12 is arranged at a position along the shutter shafts 5a and 5b in the opening portions 11 and 11 in such a manner that the spring members 7a and 7b are inserted into and locked to the opening portions 11 and 11 of the shutter members 6a and 6b by mounting the shutter shafts 5a and 5b of the shutter members 6a and 6b to the mating concave portions 4a and 4b provided in the respective arms 3a and 3b. Further, one sides 13 and 13 of the spring members 7a and 7b come into contact with the back surfaces of the shutter members 6a and 6b, a locking hole 8a of the cover 8 is fitted by the locking projections 3c and 3c of the arms 3a and 3b, and the cover 8 is fitted to the leading end side outer peripheries of the arms 3a and 3b, so that the other sides 14 of the spring members 7a and 7b are pushed down, and the shutter members 6a and 6b are always biased at the closed position.

A front surface of the upper shutter member 6a is a flat surface, and a front surface of the lower shutter member 6b is provided with a recess 15 approximately at the center, thereby being formed to prevent a leading end of a ferrule F of the female side plug P from coming into contact therewith, and being formed to allow only a front corner portion of the external sleeve S in an outer side to come into contact therewith.

A description will be next given of an example of use and motion of the embodiment configured as mentioned above.

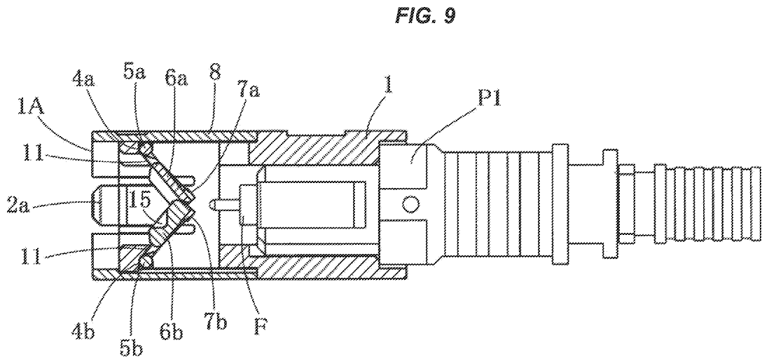

As shown in FIG. 9, the male side plug P1 is mounted to one opening end of the first adapter 1. Further, the shutter members 6a and 6b are provided at positions where the shutter members 6a and 6b are closed each other by the spring members 7a and 7b. At this time, the shutter shafts 5a and 5b of the shutter members 6a and 6b are fitted to the mating concave portions 4a and 4b of the respective arms 3a and 3b in the second adapter 1A, and are pressed by the cover 8. Thus, the closure of the butt ends of the shutter members 6a and 6b is always held firmly in the exact position.

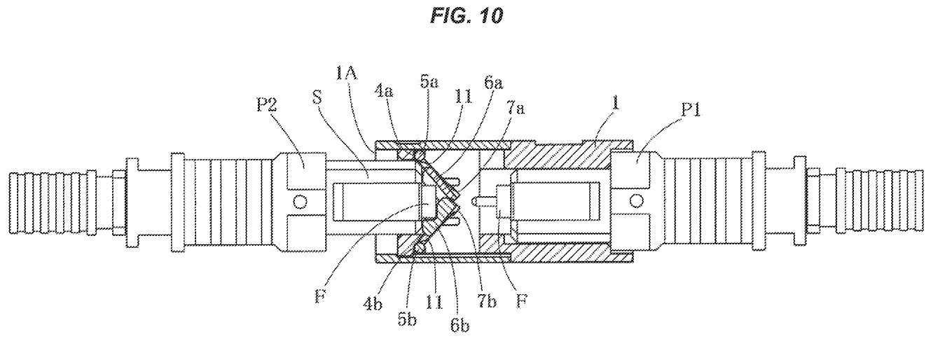

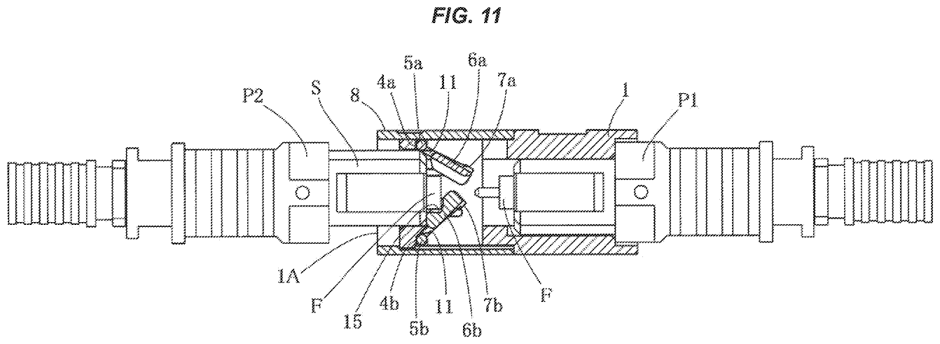

As shown in FIG. 10, when the female side plug P2 is inserted into the other opening end of the second adapter 1A, the shutter members 6a and 6b are pushed open by the front corner portion of the external sleeve as shown in FIG. 11, while avoiding the ferrule leading end by means of the recess 15 of the shutter member 6b.

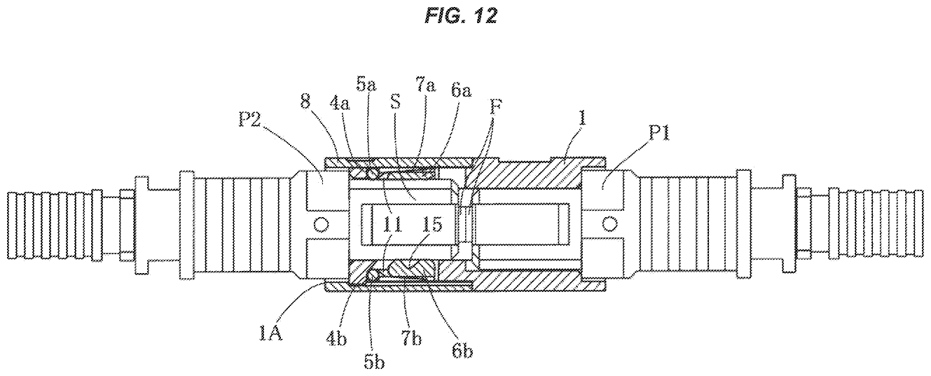

As shown in FIG. 12, when the female side plug P2 further moves, each of the shutter members 6a and 6b is opened in a horizontal direction, and is integrated with the male side plug P1, and the external sleeve S of the female side plug P2 is simultaneously locked by the stop portions 2c of the locking member 2a and 2b of the adapter 1.

As described above, in the present embodiment, the shutter shafts 5a and 5b of the shutter members 6a and 6b are rotatably fitted to the mating concave portions 4a and 4b, and are pressed by the cover 8. Thus, the closure of the butt ends of the shutter members 6a and 6b can be always held firmly in the exact position.

1. A shutter shaft holding structure in an adapter with shutter, the adapter comprising a shutter member in an insertion slot for connecting both male and female plugs, wherein U-shaped arms are protruded in the adapter to face to each other, mating concave portions are provided in the upper and lower positions of each of the arms, shutter shafts formed in respective one ends of the shutter member are fitted into the mating concave portions, and the shutter shafts are pressed by a cover put on the arms, thereby forming the shutter member so as to be axially supported within the adapter rotatably.

2. The shutter shaft holding structure in the adapter with shutter according to claim 1, wherein the adapter is formed by a first adapter into which any one of the male and female plugs is inserted and in which the U-shaped arms are provided, and a second adapter which is formed by attaching the cover to an outer periphery of the arms of the first adapter.

3. The shutter shaft holding structure in the adapter with shutter according to claim 1, wherein a pair of shutter members each including the shutter shaft in an end portion thereof are arranged in the upper and lower sides within the adapter, and at least one of the shutter members is provided with a recess with which a ferrule of the inserted adapter is not brought into contact.

4. The shutter shaft holding structure in the adapter with shutter according to claim 1, wherein the mating concave portion is arranged in a leading end side of each of the arms, and is formed into a semicircular shape so that a cylindrical shutter shaft is fitted.

5. The shutter shaft holding structure in the adapter with shutter according to claim 1, wherein a spring member is provided so that the pair of upper and lower shutter members are biased at a dosed position by pressing the shutter shaft fitted to the mating concave portion by the cover put on the arms.

6. A shutter shaft holding structure in the adapter with shutter according to claim 2, wherein a spring member is provided so that the pair of upper and lower shutter members are biased at a dosed position by pressing the shutter shaft fitted to the mating concave portion by the cover put on the arms.

7. A shutter shaft holding structure in the adapter with shutter according to claim 5, wherein the spring member is provided at the center with a bent portion so as to be inserted and locked to an opening portion formed along an inner side of the shutter shaft of the shutter member, and is formed via the bent portion into a bifurcated shape which is approximately perpendicular in a side view.

8. A shutter shaft holding structure in the adapter with shutter according to claim 6, wherein the spring member is provided at the center with a bent portion so as to be inserted and locked to an opening portion formed along an inner side of the shutter shaft of the shutter member, and is formed via the bent portion into a bifurcated shape which is approximately perpendicular in a side view.
